(19) United States
(12) Patent Application Publication
(10) Pub. No.: US 2012/0272276 A1
(43) Pub. Date: Oct. 25, 2012

(54) SYSTEM AND METHOD FOR PROVIDING VIDEO ON DEMAND OVER A QUADRATURE AMPLITUDE MODULATION NETWORK

(76) Inventors: Alex OUELLET-BELANGER, Quebec (CA); Eric Lessard, Quebec (CA); Martin Cyr, Quebec (CA); Normand Vigneault, Quebec (CA); Louis-Philippe Noel, Quebec (CA)

(21) Appl. No.: 13/451,326

(22) Filed: Apr. 19, 2012

Related U.S. Application Data
(60) Provisional application No. 61/476,999, filed on Apr. 19, 2011.

(51) Int. Cl. H04N 21/258

(52) U.S. Cl. 725/93

(57) ABSTRACT

A system for providing video on demand over a quadrature amplitude modulation network (QAMN) having a television set (TV) connected thereon, comprising a client component associated with the TV, the client component being configured to be connected between the TV and the QAMN to receive input from a user of the TV and transmit the user input over the QAMN, a controller being configured to be connected to the QAMN to receive the user input transmitted over the QAMN by the client component, a management server being configured to be connected to the controller, decode the user input and provide a new interactive user session state to a rendering server, the rendering server being configured to encode a graphical representation of the new interactive user session state in a video format and transmit the encoded graphical representation on the QAMN.

### CROSS-REFERENCE TO RELATED APPLICATIONS

This application claims the benefits of U.S. provisional patent application No. 61/476,999 filed on Apr. 19, 2011, which is herein incorporated by reference.

### TECHNICAL FIELD

The present disclosure relates to a system and method for providing video on demand over a quadrature amplitude modulation (QAM) network.

### BACKGROUND

Commonly, the TV services offered in hotels and other types of resorts rely on a coaxial cable network, which is also used to transmit video streams using quadrature amplitude modulation (QAM) for digital content or National Television System Committee (NTSC) analog content.

The current industry standards used for video streaming force some limitations on communications method using the coaxial cable network. Specifically, the coaxial cable has to be used as the transmission medium, this implies that the higher the carrier frequency, the higher the attenuation per meter. However, it must be taken into consideration that the community access television (CATV) QAM uses the 55 MHz to 1000 MHz range to carry channels 2 to 158.

Furthermore, since for any hotel or resort installation price per room is paramount, the technology used for providing video on demand should be able to use existing coaxial cable networks with a minimum amount of modifications and at a minimal cost.

Therefore, there is a need for a system and method for providing video on demand over common coaxial cable networks.

### SUMMARY

The present disclosure provides a system for providing video on demand over a quadrature amplitude modulation network having at least one television set connected thereon, comprising:
at least one client component associated with the at least one television set, the at least one client component being so configured so as to be connected between the television set and the quadrature amplitude modulation network to receive input from a user of the at least one television set and transmit the user input over the quadrature amplitude modulation network;
a controller being so configured so as to be connected to the quadrature amplitude modulation network to receive the user input transmitted over the quadrature amplitude modulation network by the client component;
a management server being so configured so as to be connected to the controller, decode the user input and provide a new interactive user session state to a rendering server;
the rendering server being so configured so as to encode a graphical representation of the new interactive user session state in a video format and transmit the encoded graphical representation of the new interactive user session state on the quadrature amplitude modulation network.

The present disclosure also provides a system for providing video on demand as above, wherein the management server being further so configured so as to:
identify the client component transmitting the user input;
associate the user input with an interactive user session;
transition from a current interactive user session state of the interactive user session to the new interactive user session state for the transmitting client component based on the decoded user input;
represent the new interactive user session state using a markup language;
provide the markup language representation of the new interactive user session state to a rendering server.

The present disclosure further provides a system for providing video on demand as above, wherein the management server is being further so configured so as to:
select a transmission channel;
transmit switching instructions to the client component based on the selected transmission channel;
provide the selected transmission channel to the rendering server;
wherein the rendering server transmits the encoded graphical representation of the new interactive user session state on the quadrature amplitude modulation network using the selected transmission channel and wherein the client component causes the at least one television set to switch to the selected transmission channel.

The present disclosure provides further still a system for providing video on demand as above, wherein the a management server is being further so configured so as to provide a movie selection to the rendering server and wherein the rendering server is being further so configured so as to transmit the selected movie on the quadrature amplitude modulation network on a selected channel and transmit switching instructions to the client based on the selected transmission channel.

The present disclosure also provides a method of performing the above.

### BRIEF DESCRIPTION OF THE FIGURES

Embodiments of the disclosure will be described by way of example only with reference to the accompanying drawings, in which:

FIG. 1 is a schematic representation of the video on demand (VoD) system in accordance with an illustrative embodiment of the present disclosure;

FIG. 2 is a flow diagram of an illustrative example of the VoD procedure when a user interacts with the VoD system of FIG. 1;

FIG. 3 is a schematic representation of an example of a content distribution network having a parallel configuration;

FIG. 4 is a schematic representation of an example of a content distribution network having a serial configuration; and

FIG. 5 is a schematic representation of an example of a content distribution network having a combined parallel and serial configuration.

Similar references used in different Figures denote similar components.

### DEFINITIONS

Management Server: component that is responsible for responding to a client request and performs the requested action.

Rendering Server: component that is responsible for generating a video stream from data, for example extensible markup language (XML) data, for distribution through a video channel.

Controller: component that is responsible for transmitting information from a client to the Management Server and from the Management Server to the Client via a network.

Client: component that is responsible for transmitting users' requests to the Controller and control an associated television set.

### DETAILED DESCRIPTION

Generally stated, the non-limitative illustrative embodiment of the present disclosure provides a system and method for providing video on demand (VoD) over a quadrature amplitude modulation (QAM) network. The purpose of the VoD system is to enable rich user interactions using commercial television (TV) sets equipped with a control port, a MPEG decoder and a QAM tuner, by the mean of near real-time movie generation on a Management Server equipped with a QAM modulator. This can be applied to meet the strict restrictions imposed by most TV sets and content distribution networks. The user typically uses an infrared (IR) remote control to transmit key information to the Management Server located in another room.

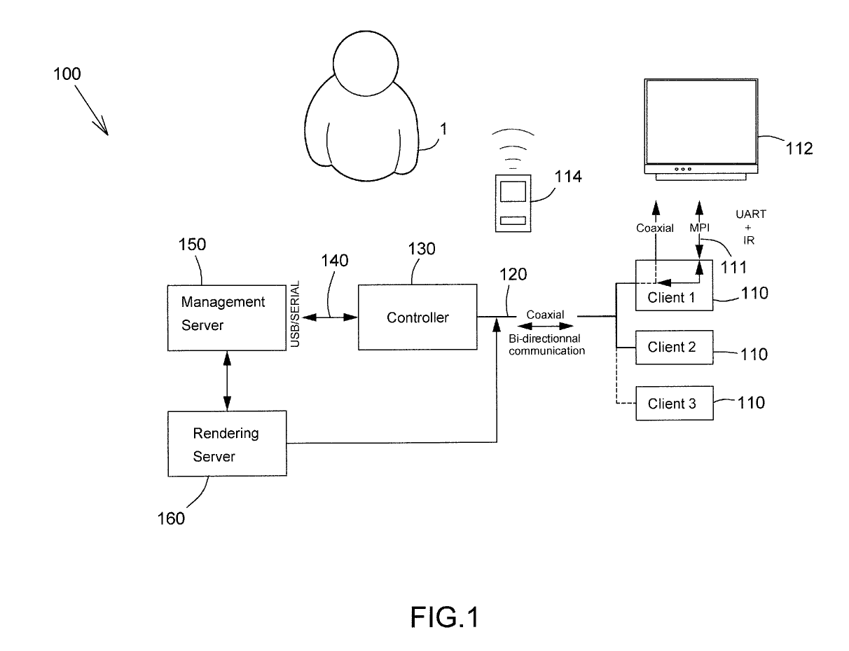

Referring to FIG. 1, the VoD system 100 generally consists of one or more Clients 110 having an associated TV set 112 and remote control 114, a content distribution network 120, a Controller 130, a local communication link 140, a Management Server 150 and a Rendering Server 160.

The user 1 interacts with the TV set 112 using the remote control 114. The Client 110 receives inputs from the user 1 in the form of infrared signals either directly from the remote control 114 or through the TV set 112, and retransmits them over the content distribution network 120 to the Management Server 150, if required, via the Controller 130 and local communication link 140, to be processed. It is to be understood that inputs relating to the changing of channels, adjusting volume, muting, etc., which do not require the use of the Management Server 150, may be processed locally by the Client 110 and/or TV set 112 and not sent over the content distribution network 120. Alternatively, all inputs may be sent to the Management Server 150, even if the use of the Management Server 150 is not required, for statistical compilation purposes.

The user 1 inputs, once processed by the Management Server 150, cause the state of the interactive session of the user 1 to be altered (when the user 1 is navigating through menus) or a movie to be transmitted (when the user 1 has selected a movie to watch). The new interactive user session state is then described using some form of markup language, for example extensible markup language (XML).

The new interactive user session state in markup language form is then submitted to the Rendering Server 160 for rendering which parses the markup to provide a graphical representation of the new interactive user session state. Once the graphical representation of the new interactive user session state is encoded in the correct video and container format, it is ready to be sent for distribution to the TV set 112 of the user 1. In the case of a movie selection, the selection is provided to the Rendering Server 160 so that it accesses the movie, for example from a movie database or other movie repository, in a video and container format that is ready to be sent for distribution to the TV set 112 of the user 1.

The TV set 112 is then tuned to the appropriate channel, if required, presenting the new interactive user session state of the user 1 (i.e. graphical user interface) or selected movie. Modern TV sets 112 generally include a radio frequency (RF) tuner, a QAM demodulator, a MPEG decoder and a display panel.

The Client 110 and the TV set 112 communicate via multiple protocol interface (MPI) 111 (i.e. TV set 112 control port) which is a proprietary protocol that is TV set 112 dependant, typically defined by the TV set 112 manufacturer. The Client 110 then communicates with the Controller 130 via the content distribution network 120 using a modulation protocol such as, but not limited to, amplitude-shift keying (ASK), frequency-shift keying (FSK) or phase-shift keying (PSK). In the illustrative embodiment, the content distribution network 120 can be a regular RG-59 or RG-6 coaxial cable network, which is a commonly available medium for interconnecting TV sets 112. To avoid any interference with existing equipment or signals, the modulated RF signals are modulated outside the QAM and National Television System Committee (NTSC) reserved frequencies used for standard channels. The modulation will be further detailed below. It is to be understood that the reserved frequencies may depend on the locally applicable telecommunications standard.

Finally, the Controller 130 communicates with the Management Server 150 via the communication link 140 via a common interface such as, but not limited to, a universal serial bus (USB) or other applicable interface.

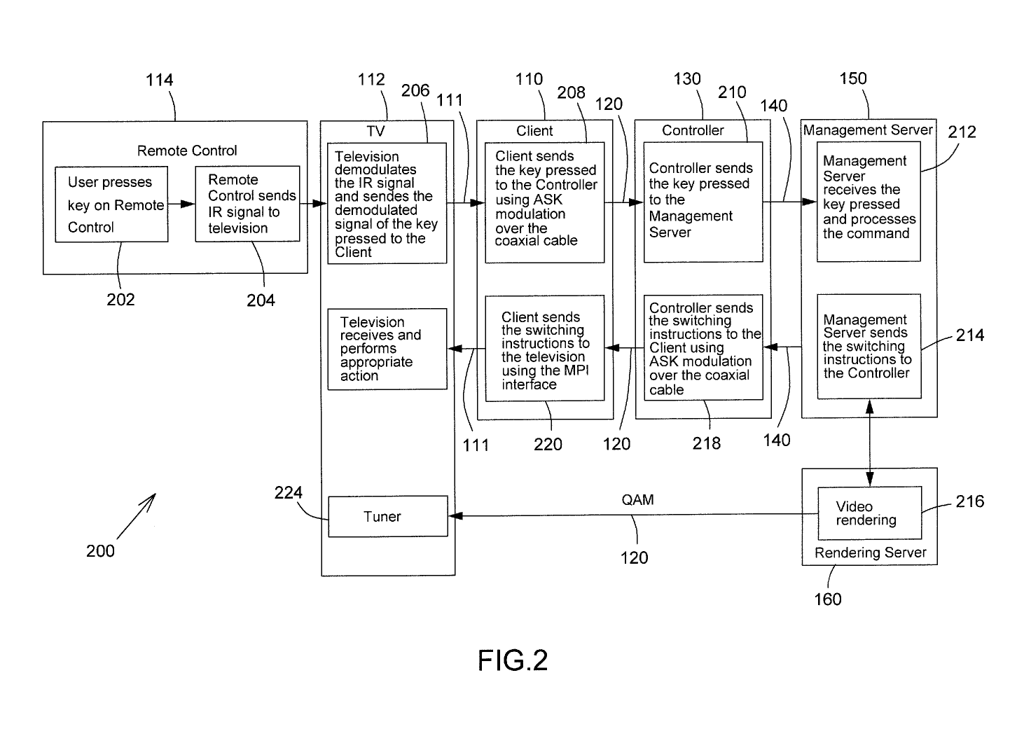

Referring now to FIG. 2, there is shown a flow diagram of an illustrative example of the VoD procedure 200 when a user 1 interacts with the VoD system 100. The steps of the procedure 200 are indicated by blocks 202 to 224.

The procedure 200 starts at block 202 when the user 1 interacts with the TV set 112 by pressing a key or a sequence of keys on the remote control 114 after which, at block 204, the remote control 114 sends a corresponding IR signal to the TV set 112.

Then, at block 206, the TV set 112 demodulates the IR signal and sends the demodulated signal to the Client 110. In an alternative embodiment, the remote control 114 may interact directly with the Client 110.

At block 208, the Client 110 determines the key or sequence of keys pressed and, if required, sends the key or sequence of keys to the Controller 130 using an ASK modulation over the coaxial cable network 120 (see FIG. 1). It is to be understood that other modulation techniques may be used.

At block 210, the Controller 130 sends the key or sequence of keys to the Management Server 150 using the USB cable (or other applicable interface).

Then, at block 212, the Management Server 150 decodes the transmitted key or sequence of keys along with information to identify the source Client 110 of the key or sequence of keys. The Management Server 150 actively maintains all of the interactive user sessions. Any key or sequence of keys received by the Management Server 150 can be associated with a specific interactive user session. The key or sequence of keys can then be used to transition from the current interactive user session state to a new interactive user session state or to select a movie to transmit. The Management Server 150 also includes all the necessary information to process those transitions; including any required logic on how a key or a sequence of keys alters an interactive user session state given an environment, the current interactive user session state and a key or a sequence of keys pressed.

The new interactive user session state can then be serialized for transmission as some form of interactive session (e.g. XML). These new interactive user session states, or scenes, now hold enough information to be presented as a new graphical user interface to the user 1. The Management Server 150 also selects a transmission channel for the new interactive session state or selected movie. This can be accomplished by the Management Server 150 keeping a map of all channels used by currently active interactive user sessions and movies or by querying the Rendering Server 160 for available channels.

At block 214, the Management Server 130 sends the selected transmission channel along with the new interactive user session state in markup language form or selected movie to the Rendering Server 160 for video rendering or transmission, at block 216, and switching instructions (to the selected transmission channel) to the Controller 130, if required, at block 218, using the USB cable (or other applicable interface).

At block 216, a graphical representation of the new interactive user session state is produced by the Rendering Server 160, which includes a rendering engine to convert the markup language to a bitmap image. This image can then be cached for future use, or generated offline to speed up the process, by mapping the source markup to the resulting image. Once rendered, the resulting image is encoded and reintroduced in the content distribution network 120 on the selected channel. In the case of a movie selection, the movie is introduced in the content distribution network 120 on the selected channel

It should be noted that in the illustrative embodiment, the content distribution network 120 uses a RF QAM video transport stream over coaxial cable. This imposes some technical constraints regarding how the graphical representation needs to be encoded and modulated. Accordingly, the graphical representation uses a MPEG compliant video in a transport stream container modulated using QAM. Furthermore, the VoD system 100 can handle multiple users interacting simultaneously, each transport stream being multiplexed into a multiple-program transport stream. Before being injected on the content distribution network 120, the transport stream is properly modulated (QAM, 8VSB, etc.)

At block 218, the Controller 130 sends the switching instructions to the Client 110 of the user 1 who pressed the key or sequence of keys following which, at block 220, the Client 110 sends the switching instructions to the TV set 112 causing the current interactive user session to change, requiring a visual update (cue, redraw, repaint). At block 224, the TV set 112 is tuned to the required channel in order to display the resulting image or movie. Because the VoD system 100 uses regular TV sets 112, the encoder must continuously feed the TV set 112 with a valid video stream.

It is to be understood that the switching instructions may also comprise instructions to remain on the same channel as that of the current interactive user session.

### Modulation

The modulation protocol is used to transmit information between the Client 110 and the Management Server 150 over the content distribution network 120. As previously mentioned, the content distribution network 120 medium that is widely used in the targeted users of the VoD system 100 is a coaxial cable network. The VoD system 100 can be used with various configurations of content distribution network 120, for example a parallel configuration, a serial configuration or a mix of both.

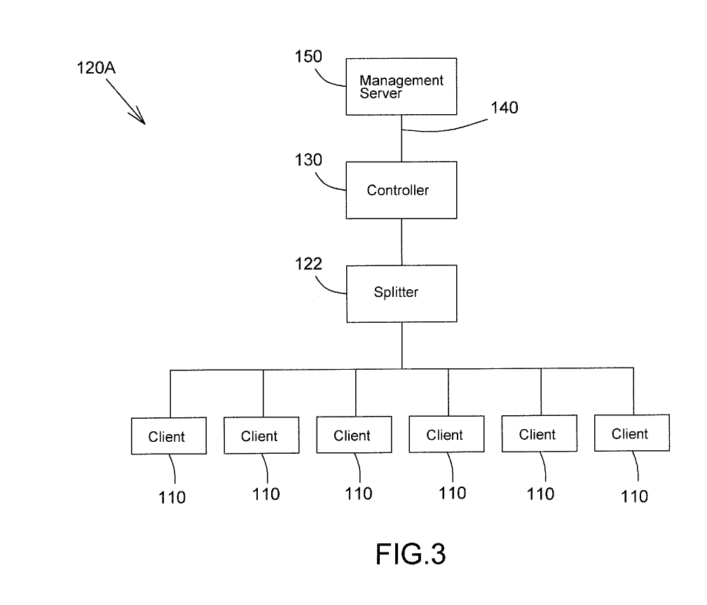

FIG. 3, shows an example of a content distribution network 120A having a parallel configuration, the Clients 110 communicating with the Controller 130 via a splitter 122.

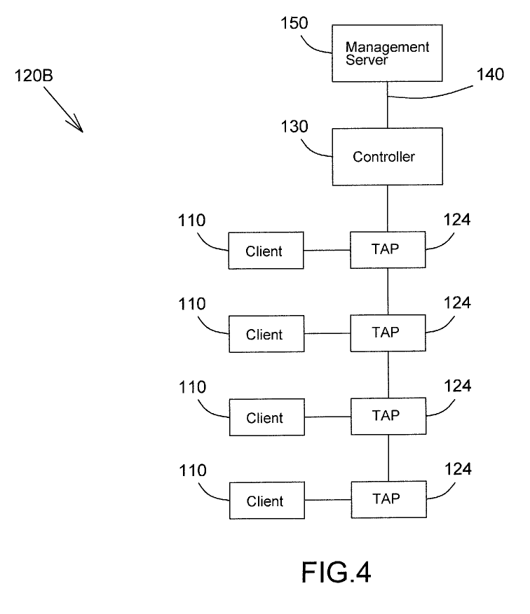

FIG. 4, shows an example of a content distribution network 120B having a serial configuration, the Clients 110 communicating with the Controller 130 via associated test access ports (TAP) 124.

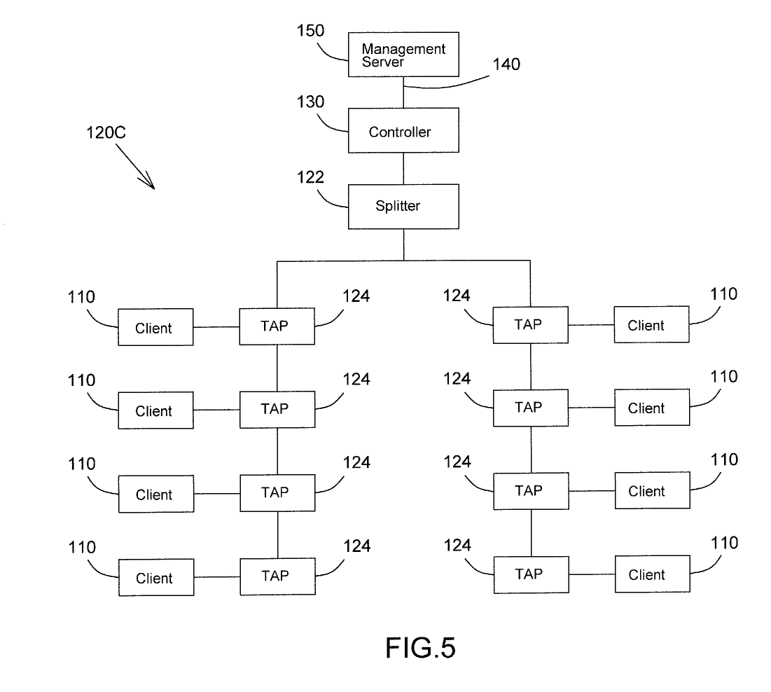

FIG. 5, shows an example of a content distribution network 120C having a combined parallel and serial configuration, the Clients 110 communicating with the Controller 130 via and associated test access ports (TAP) 124 and a splitter 122 for each parallel series of Clients 110.

In the illustrative embodiment of the present disclosure, the Clients 110 communicate with the Controller 130 via the content distribution network 120 using ASK as the modulation protocol at frequencies of 36 MHz and 75 MHz, which exploit gaps in the QAM and NTSC reserved frequencies used for standard channels. It is to be understood that in alternative embodiments, other frequencies not interfering with the QAM and NTSC reserved frequencies, or any other reserved frequencies depending on the locally applicable telecommunications standard, may be used.

In order to be able to send a command to a specific Client 110, each Client 110 is identified by a unique identifier or address, for example a media access control (MAC) address. Once a client 110 is powered up, it starts periodically sending a “I'm alive” message to the Controller 130. This purpose of this message is to create a map of all existing Clients 110 on the content distribution network 120. The Controller 130 then generates a list of all Clients 110 in its content distribution network 120 (i.e. network map).

An existing or proprietary protocol is used to encapsulate the various commands sent from the Controller 130 to the Client 110 as well as replies sent from the Client 110 to the Controller 130.

The reply contains the status of the request and/or the information requested. If such a reply does not occur within a specific time allotted, the Controller 130 determines that the Client 110 is not available and tries to send the command to the same Client 110 again.

There is a data security operation, for example a checksum, which is performed on the command sent. This data security allows the receiver (i.e. Client 110 or Controller 130) to confirm that the command is valid and complete. If the command is invalid or incomplete, the receiver (i.e. Client 110 or Controller 130) does not respond and the transmitter (i.e. Controller 130 or Client 110) acts accordingly.

It is to be understood that in alternative embodiments, the Controller 130, Management Server 150 and/or a Rendering Server 160 may be implemented on one or more physical devices.

It is further to be understood that other transmission protocols or networks may be used, for example IP based protocols/networks.

Although the present disclosure has been described with a certain degree of particularity and by way of illustrative embodiments and examples thereof, it is to be understood that the present disclosure is not limited to the features of the embodiments described and illustrated herein, but includes all variations and modifications within the scope and spirit of the disclosure as hereinafter claimed.

What is claimed:

1. A system for providing video on demand over a quadrature amplitude modulation network having at least one television set connected thereon, comprising:
at least one client component associated with the at least one television set, the at least one client component being so configured so as to be connected between the television set and the quadrature amplitude modulation network to receive input from a user of the at least one television set and transmit the user input over the quadrature amplitude modulation network;
a controller being so configured so as to be connected to the quadrature amplitude modulation network to receive the user input transmitted over the quadrature amplitude modulation network by the client component;
a management server being so configured so as to be connected to the controller, decode the user input and provide a new interactive user session state to a rendering server;
the rendering server being so configured so as to encode a graphical representation of the new interactive user session state in a video format and transmit the encoded graphical representation of the new interactive user session state on the quadrature amplitude modulation network.

2. A system for providing video on demand in accordance with claim 1, wherein the management server being further so configured so as to:
identify the client component transmitting the user input;
associate the user input with an interactive user session;
transition from a current interactive user session state of the interactive user session to the new interactive user session state for the transmitting client component based on the decoded user input;
represent the new interactive user session state using a markup language;
provide the markup language representation of the new interactive user session state to a rendering server.

3. A system for providing video on demand in accordance with claim 2, wherein the rendering server generates the graphical representation of the new interactive user session state by parsing the markup language representation of the new interactive user session state to provide the graphical representation of the new interactive user session state.

4. A system for providing video on demand in accordance with claim 1, wherein the management server is being further so configured so as to:
select a transmission channel;
transmit switching instructions to the client component based on the selected transmission channel;
provide the selected transmission channel to the rendering server;
wherein the rendering server transmits the encoded graphical representation of the new interactive user session state on the quadrature amplitude modulation network using the selected transmission channel and wherein the client component causes the at least one television set to switch to the selected transmission channel.

5. A system for providing video on demand in accordance with claim 3, wherein the management server selects the transmission channel from a map of all channels used by currently active interactive user sessions.

6. A system for providing video on demand in accordance with claim 3, wherein the management server selects the transmission channel by querying the rendering server for available channels.

7. A system for providing video on demand in accordance with claim 1, wherein the client component transmits and the controller receives the user inputs following a modulation protocol.

8. A system for providing video on demand in accordance with claim 7, wherein modulation protocol is selected from a group consisting of amplitude-shift keying, frequency-shift keying and phase-shift keying.

9. A system for providing video on demand in accordance with claim 7, wherein the modulation protocol uses frequencies outside of reserved frequencies.

10. A system for providing video on demand in accordance with claim 1, wherein the user input is selected from a group consisting of a key and sequence of keys.

11. A system for providing video on demand in accordance with claim 1, wherein the quadrature amplitude modulation network is a coaxial cable network.

12. A system for providing video on demand in accordance with claim 1, wherein the management server is being further so configured so as to provide a movie selection to the rendering server and wherein the rendering server is being further so configured so as to transmit the selected movie on the quadrature amplitude modulation network.

13. A system for providing video on demand in accordance with claim 12, wherein the management server is being further so configured so as to:
select a transmission channel;
transmit switching instructions to the client based on the selected transmission channel;
provide the selected transmission channel to the rendering server;
wherein the rendering server transmits the selected movie on the quadrature amplitude modulation network using the selected transmission channel and wherein the client component causes the at least one television set to switch to the selected transmission channel.

13. A method of providing video on demand over a quadrature amplitude modulation network having at least one television set connected thereon, comprising the steps of:
acquiring input from a user;
transmitting the user input from a first location over the quadrature amplitude modulation network;
receiving the user input at a second location from the quadrature amplitude modulation network;
decoding the user input and generate a new interactive user session state;
encoding a graphical representation of the new interactive user session state in a video format; and
transmitting the encoded graphical representation of the new interactive user session state on the quadrature amplitude modulation network.

14. A method for providing video on demand in accordance with claim 13, further comprising the steps of:
identifying the first location;
associating the user input with an interactive user session;
transitioning from a current interactive user session state of the interactive user session to the new interactive user session state for the first location based on the decoded user input;
representing the new interactive user session state using a markup language;
parsing the markup language representation of the new interactive user session state to provide the graphical representation of the new interactive user session state.

15. A method for providing video on demand in accordance with claim 13, further comprising the steps of:
selecting a transmission channel;
transmitting switching instructions to the first location based on the selected transmission channel;
wherein the rendering server transmits the encoded graphical representation of the new interactive user session state is transmitted on the quadrature amplitude modulation network using the selected transmission channel and wherein the at least one television set is switched to the selected transmission channel.

16. A method for providing video on demand in accordance with claim 13, wherein the user inputs are transmitted over the quadrature amplitude modulation network following a modulation protocol.

17. A method for providing video on demand in accordance with claim 16, wherein modulation protocol is selected from a group consisting of amplitude-shift keying, frequency-shift keying and phase-shift keying.

18. A method for providing video on demand in accordance with claim 16, wherein the modulation protocol uses frequencies outside of reserved frequencies.

19. A method for providing video on demand in accordance with claim 13, wherein the user input is selected from a group consisting of a key and sequence of keys.

20. A method for providing video on demand in accordance with claim 13, wherein the quadrature amplitude modulation network is a coaxial cable network.

21. A method for providing video on demand in accordance with claim 13, further comprising the steps of selecting a movie and transmitting the selected movie on the quadrature amplitude modulation network.

22. A method for providing video on demand in accordance with claim 21, further comprising the steps of
selecting a transmission channel;
transmitting the selected movie on the quadrature amplitude modulation network using the selected transmission channel
switching the at least one television set to the selected transmission channel.
